(19) United States
(12) Patent Application Publication
(10) Pub. No.: US 2012/0089970 A1
(43) Pub. Date: Apr. 12, 2012

(54) APPARATUS AND METHOD FOR CONTROLLING LOOP SCHEDULE OF A PARALLEL PROGRAM

(76) Inventors: Byung-Chang Cha, Seoul (KR); Sung-Do Moon, Seongnam-si (KR); Dae-Hyun Cho, Suwon-si (KR)

(21) Appl. No.: 13/108,787

(22) Filed: May 16, 2011

(30) Foreign Application Priority Data
Oct. 12, 2010 (KR) 10-2010-0099479

(51) Int. Cl. G06F 9/45

(52) U.S. Cl. 717/150

(57) ABSTRACT

A compiling apparatus and method are provided. The compiling apparatus includes a first setting unit that sets a first parameter of a parallel programming model for a parallel region of a caller, a callee detection unit that detects a callee that is called by the caller and that has at least one loop region, and a second setting unit that sets a second parameter of the parallel programming model for the loop region of the callee using the first parameter.

### CROSS-REFERENCE TO RELATED APPLICATION(S)

This application claims the benefit under 35 U.S.C. §119(a) of Korean Patent Application No. 10-2010-0099479, filed on Oct. 12, 2010, in the Korean Intellectual Property Office, the entire disclosure of which is incorporated herein by reference for all purposes.

### BACKGROUND

1. Field

The following description relates to a parallel program model for use in a multicore architecture.

2. Description of the Related Art

Multicore systems equipped with multiple CPUs have been widely used not only in computers but also in various other products such as TVs, mobile phones, and the like.

A parallel programming model is a programming technique that allows multiple processes in a program to be executed at the same time, and is one of the most-widely used methods for developing programs that are executable in multicore systems.

Examples of the parallel program model include OPENMP® that allows a particular block of code to operate as a multithread with the use of a simple directive. Most compilers including GNU Compiler Collection (GNU), INTEL® Compiler, MICROSOFT® Visual Studio, and the like, support OPENMP® directives.

The parallel programming model is mostly used in multicore systems. For universal use in systems that have different architectures, the parameters of programming need to be appropriately adjusted. However, it is very difficult or even impossible to search for optimal environment variables for all parallel-processing regions.

### SUMMARY

In one general aspect, there is provided a compiling apparatus including a first setting unit configured to set a first parameter of a parallel programming model for a parallel region of a caller, a callee detection unit configured to detect a callee that is called by the caller and that has at least one loop region, and a second setting unit configured to set a second parameter of the parallel programming model for the loop region of the callee using the first parameter.

The first or second parameter may include at least one of a number of threads generated in the parallel region, a static scheduling policy, a dynamic scheduling policy, a guided scheduling policy, scheduling chunk size, and CPU affinity.

The callee detection unit may detect a function that has at least one parallel loop region that is not nested in a parallel region.

The callee detection unit may detect a function that has at least one #pragma omp for that is not nested in #pragma omp parallel.

In another aspect, there is provided a compiling apparatus including a first setting unit configured to set a first scheduling method for a parallel region of a caller, a callee detection unit configured to detect a callee that is called by the caller and that has at least one loop region, and a second setting unit configured to set a second scheduling method for the loop region of the callee based on the first scheduling method.

The callee detection unit may detect a function that has at least one parallel loop region that is not nested in a parallel region.

The callee detection unit may detect a function that has at least one #pragma omp for that is not nested in #pragma omp parallel.

The second setting unit may insert a function that sets a scheduling method into the beginning of the parallel region of the caller and that sets runtime scheduling as the second scheduling method.

If the first scheduling method is static scheduling, the second setting unit may generate a function that is the same as the callee and is set to static scheduling, and rename the callee after the generated function so that the generated function is called when the callee is called.

The first or second scheduling method may include a scheduling policy or type and scheduling chunk size.

In another aspect, there is provided a scheduling method including setting a first scheduling method for a parallel region of a caller, detecting a callee that is called by the caller and that has at least one loop region, and setting a second scheduling method for the loop region of the callee based on the first scheduling method.

The detecting the callee may comprise detecting a function that has at least one parallel loop region that is not nested in a parallel region.

The detecting the callee may further comprise detecting a function that has at least one #pragma omp for that is not nested in #pragma omp parallel.

The setting the second scheduling method may comprise inserting a function that sets a scheduling method into the beginning of the parallel region of the caller and setting runtime scheduling as the second scheduling method.

If the first scheduling method is static scheduling, the setting the second scheduling method may comprise generating a function that is the same as the callee and that is set to static scheduling, and renaming the callee after the generated function so that the generated function is called when the callee is called.

The first or second scheduling method may include a scheduling policy or type and scheduling chunk size.

Other features and aspects may be apparent from the following detailed description, the drawings, and the claims.

### BRIEF DESCRIPTION OF THE DRAWINGS

FIG. 1 is a diagram illustrating an example of a compiler apparatus.

FIG. 2 is a diagram illustrating an example of source code.

FIG. 3 is a diagram illustrating another example of a compiling apparatus.

FIG. 4 is a diagram illustrating another example of source code.

FIG. 5A is a diagram illustrating another example of source code.

FIG. 5B is a diagram illustrating an example of source code for adjusting a scheduling method of a callee function.

FIG. 5C is a diagram illustrating another example of source code for adjusting a scheduling method of a callee function.

FIG. 6 is a flowchart illustrating an example of a compiling method.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

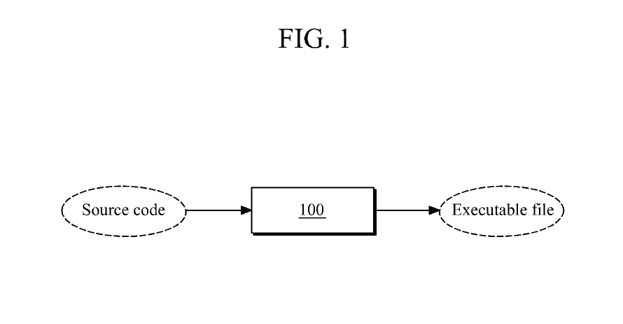

FIG. 1 illustrates an example of a compiling apparatus.

Referring to FIG. 1, compiling apparatus 100 converts source code into a file that can be executed by a computer. For example, the compiling apparatus 100 may include a compiler for converting a high-level language into a machine language or an assembler for converting the machine language into a file that can be executed by a computer. The compiling apparatus 100 may be included in a terminal, for example, a computer, a mobile terminal, an MP3, and the like.

The source code may be written using a parallel programming model. The parallel programming model is a programming language model that allows at least part of the source code to operate as a multithread with the aid of a particular directive. Examples of the parallel programming model include, but are not limited to, OPENMP®, OPENCL®, CILK®, Threading Building Blocks (TBB), and the like.

The compiling apparatus 100 may support the parallel programming model. For example, when processing source code that is written based on the parallel programming mode, the compiling apparatus 100 may generate multiple threads to a particular portion of the source code to be processed in parallel, in response to a particular directive included in the source code.

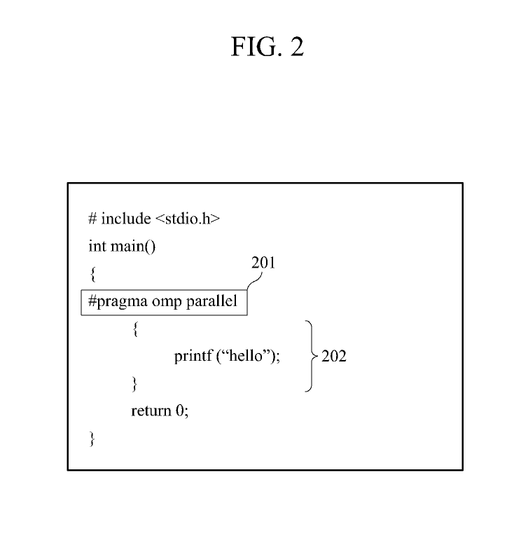

FIG. 2 illustrates an example of source code. In this example the source code is written based on OPENMP®.

Referring to FIG. 2, source code includes a parallel pragma 201. Due to the parallel pragma 201, a portion of the source code may be defined as a parallel region 202. For example, when the source code is executed, a plurality of threads corresponding to the parallel region 202 may be generated. As a result, a string such as “hello” may be printed a plurality of number of times.

The number of times that the string “hello” is printed may be determined by various environment variables and option parameters that are supported by the parallel programming model. For example, the number of times that the string “hello” is printed may be determined by a parameter for adjusting the number of threads to be generated. Examples of the parameters supported by the parallel programming mode include, but are not limited to, a scheduling policy (or type) such as a static scheduling policy, a dynamic scheduling policy, and a guided scheduling policy, the size of chunks to be used in scheduling, and/or CPU affinity that indicates a system core to which threads are to be allocated.

Referring to FIGS. 1 and 2, the compiling apparatus 100 may automatically generate an optimal parallel programming model parameter set for the parallel region 202. For example, the compiling apparatus 100 may measure the amount of time that it takes to process the parallel region 202 using various combinations of a plurality of parallel programming model parameters such as, for example, the number of threads to be generated, a scheduling policy or type, the size of chunks to be used in scheduling, and CPU affinity. The compiling apparatus 100 may select an optimal parameter set for the parallel region 202 from the various combinations of the parallel programming model parameters, based on the results of the measurement.

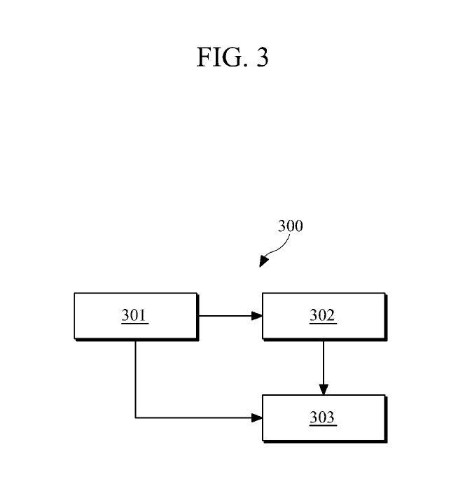

FIG. 3 illustrates another example of a compiling apparatus.

Referring to FIG. 3, compiling apparatus 300 includes a first setting unit 301, a callee detection unit 302, and a second setting unit 303.

The first setting unit 301 may set an optimal set of parallel programming model parameters for a parallel region of a caller. In this example, the caller may be a function that calls another function and that includes a parallel region therein. The first setting unit 301 may execute the parallel region of the caller a number of times while adjusting various parallel programming model parameters such as, for example, the number of threads, a scheduling policy or type, the size of chunks to be used in scheduling, and CPU affinity, and may determine an optimal parameter set that can increase and/or maximize the performance of the execution of the parallel region of the caller.

For example, the first setting unit 301 may execute the parallel region of the caller using each of the static, dynamic, and guided scheduling policies. Accordingly, the first setting unit 301 may set whichever of the static, dynamic, and guided scheduling policies that produces the best performance regarding processing time as an optimal scheduling policy for the parallel region of the caller.

The callee detection unit 302 may detect a callee that is called by the caller. For example, the callee may have at least one loop region. In this example, the callee may be a function that is called by the caller and that has at least one parallel loop region. The callee, like the caller, may include a parallel region therein. For example, the callee may have a parallel loop region that is defined by #pragma omp for and that is not nested in #pragma omp parallel. For example, the callee detection unit 302 may detect the callee by analyzing a call graph for the source code.

The second setting unit 303 may set the same parameter set applied to the parallel region of the caller by the first setting unit 301 as an optimal parameter set for the loop region of the callee. For example, the second setting unit 303 may set the same scheduling policy applied to the parallel region of the caller by the first setting unit 301 as an optimal scheduling policy for the loop region of the callee.

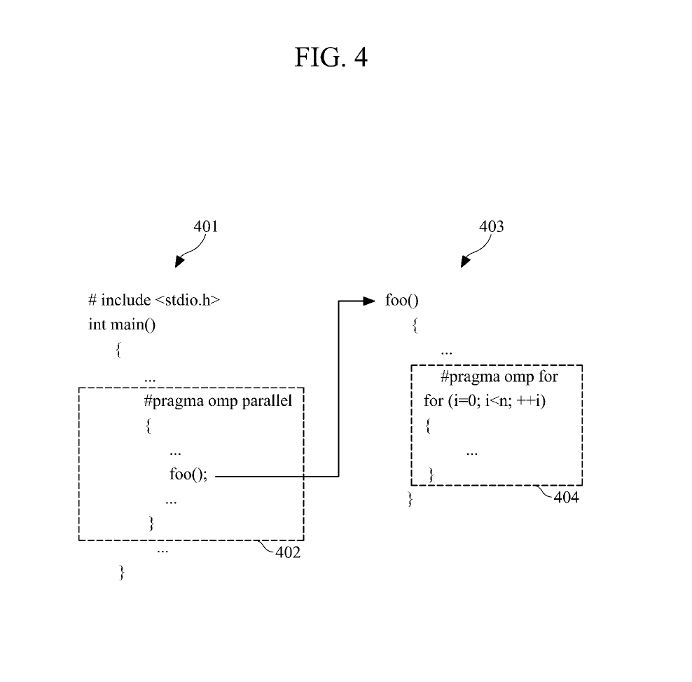

FIG. 4 illustrates another example of source code.

Referring to FIGS. 3 and 4, the first setting unit 301 may set a first scheduling method for a caller 401. For example, the first setting unit 301 may execute a parallel region 402 of the caller 401 using each of the static, dynamic, and guided scheduling policies. Accordingly, the first setting unit 301 may select whichever of the static, dynamic and guided scheduling policies produces the best performance as the first scheduling method for the parallel region 402. The first scheduling method may include a scheduling policy (or type) and the size of chunks to be used in scheduling.

The callee detection unit 302 may detect a function called by the parallel region 402 of the caller 401. For example, the callee detection unit 302 may analyze a call graph of the source code, and may detect a callee 403 that has a loop pragma (e.g., #pragma omp for) that is not nested in a parallel pragma (e.g., #pragma omp parallel).

The second setting unit 303 may set a scheduling method for a loop region 404 of the callee 403 in accordance with the first scheduling method. For example, if the first scheduling method includes static scheduling, the second setting unit 303 may set static scheduling as an optimal scheduling policy for the loop region 404 of the callee 403. As another example, if the first scheduling method includes dynamic or guided scheduling, the second setting unit 303 may set dynamic or guided scheduling as an optimal scheduling policy for the loop region 404 of the callee 403.

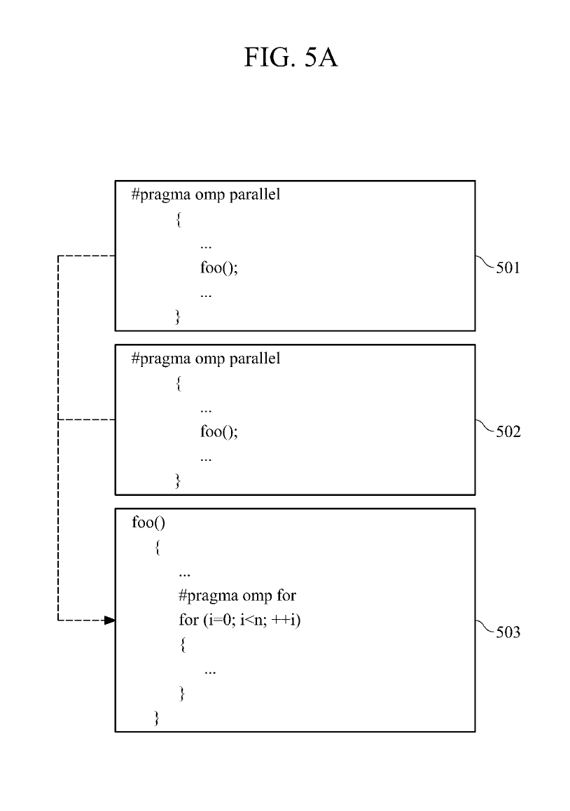

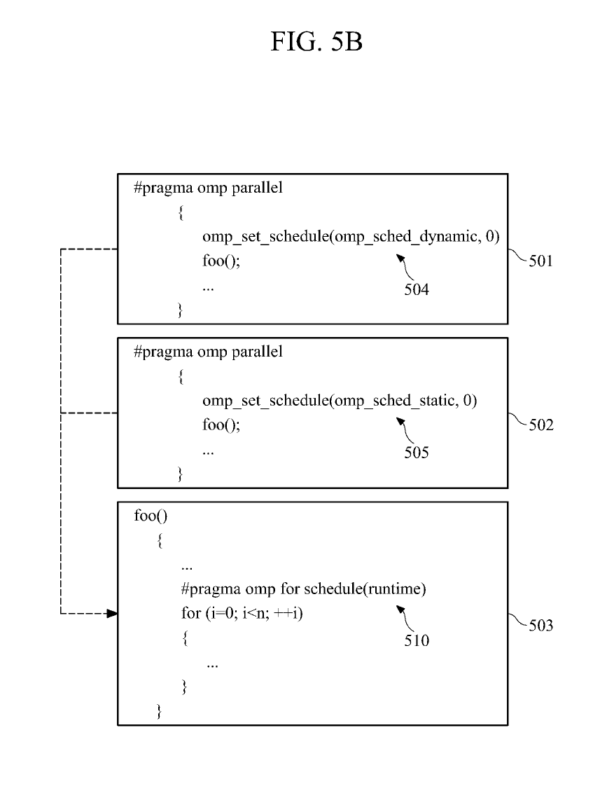

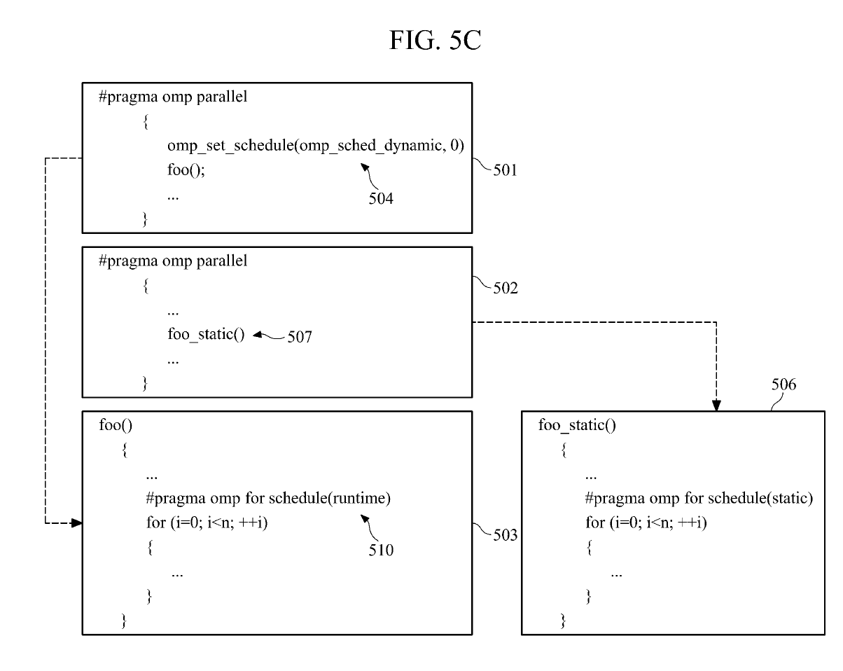

An example of setting a scheduling method for a callee is further described with reference to FIGS. 5A through 5C.

FIG. 5A illustrates another example of source code.

Referring to FIG. 5A, parallel region A (501) and parallel region B (502) call a function ‘foo’ (503). For example, the first setting unit 301 shown in FIG. 3 may set the dynamic and static scheduling policies for parallel regions A (501) and B (502), respectively, as optimal scheduling polices.

FIG. 5B illustrates an example of source code for adjusting a scheduling method of callee function 503.

Referring to FIGS. 3 and 5B, the second setting unit 303 may change the scheduling policy for the callee function 503 to runtime scheduling. For example, the second setting unit 303 may add a parameter 501 that determines the type of scheduling during runtime for #pragma omp for. In addition, the second setting unit 303 may insert application programming interfaces 504 and 505 that determine the type of scheduling and the size of chunks for parallel region A (501) and parallel region B (502), respectively.

Referring to FIG. 5B, because dynamic scheduling is set as the scheduling policy for parallel region A (501), omp_set_schedule (omp_sched_dynamic, 0) may be inserted into parallel region A (501) as the API 504. For example, the API 504 may be a scheduling command that is based on a scheduling chunk size of 0 and dynamic scheduling. Therefore, when the callee function 503 that has a runtime schedule is called by parallel region A (501), dynamic scheduling may be performed on the callee function 503.

Because static scheduling is set as the scheduling policy for parallel region B (502), omp_set_schedule (static, 0) may be inserted into parallel region B (502) as the API 505. For example, the API 505 may be a scheduling command that is based on a scheduling chunk size of 0 and static scheduling. Therefore, when the callee function 503 having a runtime schedule is called by parallel region B (502), static scheduling may be performed on the callee function 503.

FIG. 5C illustrates another example of source code for adjusting a scheduling method of callee function 503.

Referring to FIGS. 3 and 5C, the second setting unit 303 may copy the callee function 503 and may generate a ‘static scheduling-only’ function 506. For example, the second setting unit 303 may generate, through function versioning, a function ‘foo_static’ which is similar to the function ‘foo’ except that it has a scheduling policy that is fixed to static scheduling. In this example, the second setting unit 303 may rename the ‘static scheduling-only’ function 506 as ‘foo_static,’ as indicated by reference numeral 507.

Referring to FIG. 5C, because dynamic scheduling is set as the scheduling policy for parallel region A (501), an API 504 such as omp_set_schedule (omp_sched_dynamic, 0) may be inserted into parallel region A (501). As a result, when the callee function 503 that has a runtime schedule is called by parallel region A (510), the callee function 503 and parallel region A (501) may both be subject to dynamic scheduling.

Because static scheduling is set as the scheduling policy for parallel region B (502), and the ‘static scheduling-only’ function 506 that has the same function as the callee function 503 is called by parallel region B (502), the callee function 503 may be subject to static scheduling.

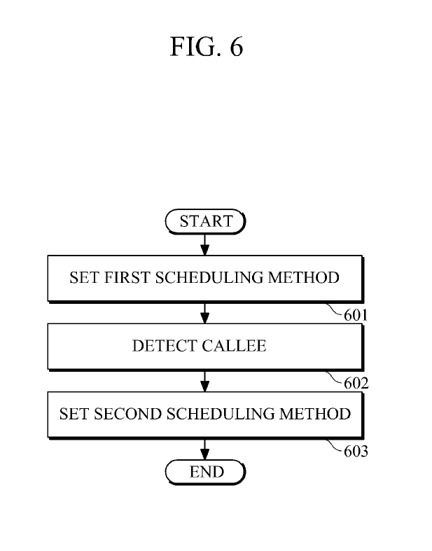

FIG. 6 illustrates an example of a compiling method.

Referring to FIG. 6, a first scheduling method is set, in 601. The first scheduling method may specify an optimal scheduling policy for a function that calls another function and that has a parallel region and an optimal scheduling chunk size for the function. For example, referring to FIG. 3, the first setting unit 301 may search for an optimal scheduling method for a parallel region of a caller using various combinations of a plurality of parallel programming model parameters.

In 602, a callee is detected. The callee may be a function that is called by a caller and that has at least one loop region. For example, the callee may be a function that has at least one #pragma omp for that is not nested in #pragma omp parallel. The callee may be detected through the analysis of a call graph of source code by the callee detection unit 302 shown in FIG. 3.

In 603, a second scheduling method is set. The second scheduling method may be an optimal scheduling method for a function that is called by a function that has a parallel region and has a loop region. For example, the second setting unit 303 shown in FIG. 3 may set the same scheduling method applied to a parallel region as an optimal scheduling method for a callee that is called by the parallel region. The setting of a scheduling method for a callee may be performed through the addition of a particular command or the copying of a function, as shown in the examples of FIGS. 5A through 5C.

As described above, because the scheduling method for a callee is modified in accordance with the scheduling method for a caller, it is possible to set an optimal scheduling method even for a parallel loop region that is not nested in a parallel region of the caller.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A compiling apparatus comprising:
a first setting unit configured to set a first parameter of a parallel programming model for a parallel region of a caller;
a callee detection unit configured to detect a callee that is called by the caller and that has at least one loop region; and
a second setting unit configured to set a second parameter of the parallel programming model for the loop region of the callee using the first parameter.

2. The compiling apparatus of claim 1, wherein the first or second parameter includes at least one of a number of threads generated in the parallel region, a static scheduling policy, a dynamic scheduling policy, a guided scheduling policy, scheduling chunk size, and CPU affinity.

3. The compiling apparatus of claim 1, wherein the callee detection unit detects a function that has at least one parallel loop region that is not nested in a parallel region.

4. The compiling apparatus of claim 3, wherein the callee detection unit detects a function that has at least one #pragma omp for that is not nested in #pragma omp parallel.

5. A compiling apparatus comprising:
a first setting unit configured to set a first scheduling method for a parallel region of a caller;
a callee detection unit configured to detect a callee that is called by the caller and that has at least one loop region; and
a second setting unit configured to set a second scheduling method for the loop region of the callee based on the first scheduling method.

6. The compiling apparatus of claim 5, wherein the callee detection unit detects a function that has at least one parallel loop region that is not nested in a parallel region.

7. The compiling apparatus of claim 5, wherein the callee detection unit detects a function that has at least one #pragma omp for that is not nested in #pragma omp parallel.

8. The compiling apparatus of claim 5, wherein the second setting unit inserts a function that sets a scheduling method into the beginning of the parallel region of the caller and that sets runtime scheduling as the second scheduling method.

9. The compiling apparatus of claim 5, wherein, if the first scheduling method is static scheduling, the second setting unit generates a function that is the same as the callee and is set to static scheduling, and renames the callee after the generated function so that the generated function is called when the callee is called.

10. The scheduling apparatus of claim 5, wherein the first or second scheduling method includes a scheduling policy or type and scheduling chunk size.

11. A scheduling method comprising:
setting a first scheduling method for a parallel region of a caller;
detecting a callee that is called by the caller and that has at least one loop region; and
setting a second scheduling method for the loop region of the callee based on the first scheduling method.

12. The compiling method of claim 11, wherein the detecting the callee comprises detecting a function that has at least one parallel loop region that is not nested in a parallel region.

13. The compiling method of claim 12, wherein the detecting the callee further comprises detecting a function that has at least one #pragma omp for that is not nested in #pragma omp parallel.

14. The compiling method of claim 11, wherein the setting the second scheduling method comprises inserting a function that sets a scheduling method into the beginning of the parallel region of the caller and setting runtime scheduling as the second scheduling method.

15. The compiling method of claim 11, wherein, if the first scheduling method is static scheduling, the setting the second scheduling method comprises generating a function that is the same as the callee and that is set to static scheduling, and renaming the callee after the generated function so that the generated function is called when the callee is called.

16. The scheduling method of claim 11, wherein the first or second scheduling method includes a scheduling policy or type and scheduling chunk size.
